(19) United States
(12) Patent Application Publication
(10) Pub. No.: US 2012/0240224 A1
(43) Pub. Date: Sep. 20, 2012

(54) SECURITY SYSTEMS AND METHODS FOR DISTINGUISHING USER-INTENDED TRAFFIC FROM MALICIOUS TRAFFIC

(75) Inventors: Bryan Douglas Payne, Atlanta, GA (US); Brendan Dolan-Gavitt, Atlanta, GA (US); Wenke Lee, Atlanta, GA (US)

(73) Assignee: Georgia Tech Research Corporation, Atlanta, GA (US)

(21) Appl. No.: 13/232,830

(22) Filed: Sep. 14, 2011

Related U.S. Application Data
(60) Provisional application No. 61/382,664, filed on Sep. 14, 2010.

(51) Int. Cl. G06F 21/00

(52) U.S. Cl. 726/21

(57) ABSTRACT

Security systems and methods distinguish user-intended input hardware events from malicious input hardware events, thereby blocking resulting malicious output hardware events, such as, for example, outgoing network traffic. An exemplary security system can comprise an event-tracking unit, an authorization unit, and an enforcement unit. The event-tracking unit can capture a user-initiated hardware event. The authorization unit can analyze a user interface to determine whether the input hardware event should initiate outgoing hardware events and, if so, to create an authorization specific to the outgoing event initiated by the input event. This authorization can be stored in an authorization database. The enforcement unit can monitor outgoing hardware events and block the outgoing events for which no authorization matching the outgoing events are found in the authorization database.

### CROSS-REFERENCE TO RELATED APPLICATIONS

This application claims a benefit under 35 U.S.C. §119(e) of U.S. Provisional Application Ser. No. 61/382,664, filed 14 Sep. 2010, the entire contents and substance of which are hereby incorporated by reference as if fully set forth below.

### TECHNICAL FIELD

Various embodiments of the present invention relate to computer security and, particularly, to security systems and methods for distinguishing user-intended network traffic from malicious network traffic.

### BACKGROUND

Computers are often compromised and then used as computing resources by attackers to carry out malicious activities, such as distributed denial of service (DDoS), spam, and click fraud. Distinguishing between network traffic resulting from legitimate user activities and illegitimate malware activities proves difficult, because many of the activities performed by modern malware (e.g., bots) are similar to activities performed by users on their computers. For example, users send email, while malware sends analogous spam. Users view web pages, while malware commits click-fraud. Further, instead of using customized or rarely used protocols that would arouse suspicion, malware is known to tunnel malicious traffic through commonly used protocols, such as hypertext transfer protocol (HTTP), to give it the appearance of legitimate application traffic. To this end, malware may run an application protocol or inject itself into a legitimate application. Malware can also mimic user activity patterns, such as time-of-day and frequency, and can morph and change tactics in response to detection heuristics and methods to hide its malicious activities and traffic.

Existing security technologies, such as firewalls, anti-virus, intrusion detection and prevention systems, and botnet security systems, all fail or have a significant capability gap in detecting and stopping malicious traffic, particularly where that traffic is disguised as legitimate application traffic. For example, host-based application firewalls allow traffic from legitimate applications and thus cannot stop malicious traffic from malware that has injected itself into a legitimate application. Previous systems aimed at distinguishing user-intended network traffic, based on timing information of user input, lack the precision necessary to identify traffic created by malicious code injected into a legitimate process and sent shortly after a user input event.

### SUMMARY

There is a need in the art for security systems and methods to precisely identify hardware events, such as network traffic, initiated by users and to block hardware events that are not deemed to be user-initiated. It is to such systems and methods that various embodiments of the invention are directed.

Briefly described, an exemplary embodiment of the present security system can comprise an event-tracking unit, an authorization unit, and an enforcement unit. These units of the security system can reside in a trusted virtual machine on a host, while the user can interact with the host through an untrusted user virtual machine.

The event-tracking unit can capture certain hardware events from user input devices, such as a keyboard or a mouse, which hardware events must be initiated by a user. By reconstructing the user interface of the user virtual machine, the event-tracking unit can determined whether the user input event was intended to initiate specific one or more outgoing hardware events, such as network traffic. If so, the event-tracking unit can pass information about the expected outgoing hardware events to the authorization unit. Otherwise, the event-tracking unit can ignore the user input event, generating no corresponding authorization.

After receiving notification of a user input event from the event-tracking unit, the authorization unit can generate an authorization that is specific to each outgoing hardware event expected as a result of the user input event in question. For example, and not limitation, if it is determined that the user input event initiates transmission of an email message, the authorization unit can generate an authorization comprising the recipient, subject, and content of the message appearing on the user interface when the user clicked the send button. The authorization can be stored in an authorization database.

The enforcement unit can monitor outgoing hardware events and can block any outgoing hardware events for which a corresponding authorization cannot be identified in the authorization database. For example, if the enforcement unit identifies that an email message is being sent, the enforcement unit can attempt to match the recipient, subject and content of the message to an authorization in the database. If such an authorization is identified, then the enforcement unit can allow the email message to be sent. Otherwise, the enforcement unit can block the email message from being sent. Resultantly, hardware events, including network traffic, that are not identified as being a direct result of user input events can be blocked.

These and other objects, features, and advantages of the security system will become more apparent upon reading the following specification in conjunction with the accompanying drawing figures.

### BRIEF DESCRIPTION OF THE FIGURES

FIG. 1 illustrates a diagram of the security system, according to an exemplary embodiment of the present invention.

FIG. 2 illustrates an example of a suitable computing device that can be used as or can comprise a portion of a host on which the security system can operate, according to an exemplary embodiment of the present invention.

FIG. 3 illustrates a flow diagram of a method authorization and enforcement of network traffic, according to an exemplary embodiment of the present invention.

FIG. 4 illustrates an example of a reconstructed interface of the user virtual machine, according to an exemplary embodiment of the present invention.

FIG. 5 illustrates a flow chart depicting how authorization and enforcement are linked by the authorization database, according to an exemplary embodiment of the present invention.

### DETAILED DESCRIPTION

To facilitate an understanding of the principles and features of the invention, various illustrative embodiments are explained below. In particular, the invention is described in the context of being a security system for blocking network traffic that is not user-initiated. In some exemplary embodiments, the security system utilizes virtualization to remain isolated from malicious tampering. Embodiments of the invention, however, are not limited to blocking network traffic but can be used to block various types of outgoing hardware events. Embodiments are further not limited to virtualization contexts. Rather, embodiments of the invention can be implemented over various architectures that are capable of isolating aspects of the invention from malicious processes.

The components described hereinafter as making up various elements of the invention are intended to be illustrative and not restrictive. Many suitable components that can perform the same or similar functions as components described herein are intended to be embraced within the scope of the invention. Such other components not described herein can include, but are not limited to, similar or analogous components developed after development of the invention.

Various embodiments of the present invention are security systems to filter network traffic. Referring now to the figures, in which like reference numerals represent like parts throughout the views, various embodiment of the security system will be described in detail.

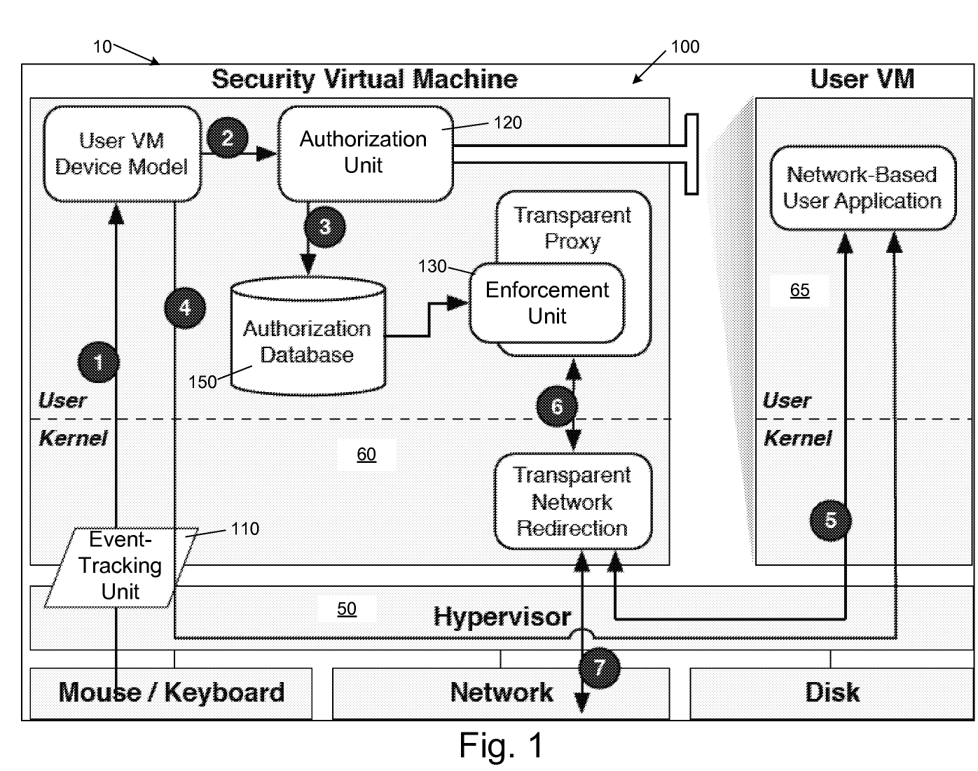

FIG. 1 illustrates a diagram of the security system, according to an exemplary embodiment of the present invention. As shown, the security system 100 can comprise an event-tracking unit 110, an authorization unit 120, and an enforcement unit 130. In some embodiments of the security system that utilize virtualization, all or a portion of the event-tracking unit 110, the authorization unit 120, and the enforcement unit 130 can reside in a trusted virtual machine 60 of a host computing device 10.

Because malware is not a human user, traffic from malware is not directly initiated by user activities on a host. Malware cannot reproduce hardware events, such as those from the keyboard or the mouse. Thus, the security system 100 can operate under the assumption that user-initiated traffic is allowable, and non-user-initiated traffic should be blocked. The security system 100 can provide an efficient and robust approach, based on virtual machine introspection techniques that use hardware events combined with memory analysis to authorize outgoing application traffic.

The event-tracking unit 110 can capture hardware events provided by user input devices, which can be assumed to have been initiated by a user. The authorization unit 120 can interpret the user's intent based on his interactions with the host 10 and the semantics of the application that receives the user input. The authorization unit 120 can dynamically encapsulate the user inputs into a security authorization, which can be used by the enforcement unit 130 used to distinguish legitimate user-initiated hardware events from illegitimate malware-initiated events. Through the security system 100, a host 10 can prevent malware from misusing networked applications to send malicious network traffic even when the malware runs an application protocol or injects itself into a legitimate application.

Each of the event-tracking unit 110, the authorization unit 120, and the enforcement unit 130 can comprise hardware, software, or a combination of both. Although these units are described herein as being distinct components of the security system 100, this need not be the case. The units are distinguished herein based on operative distinctiveness, but they can be implemented in various fashions. The elements or components making up the various units can overlap or be divided in a manner other than that described herein.

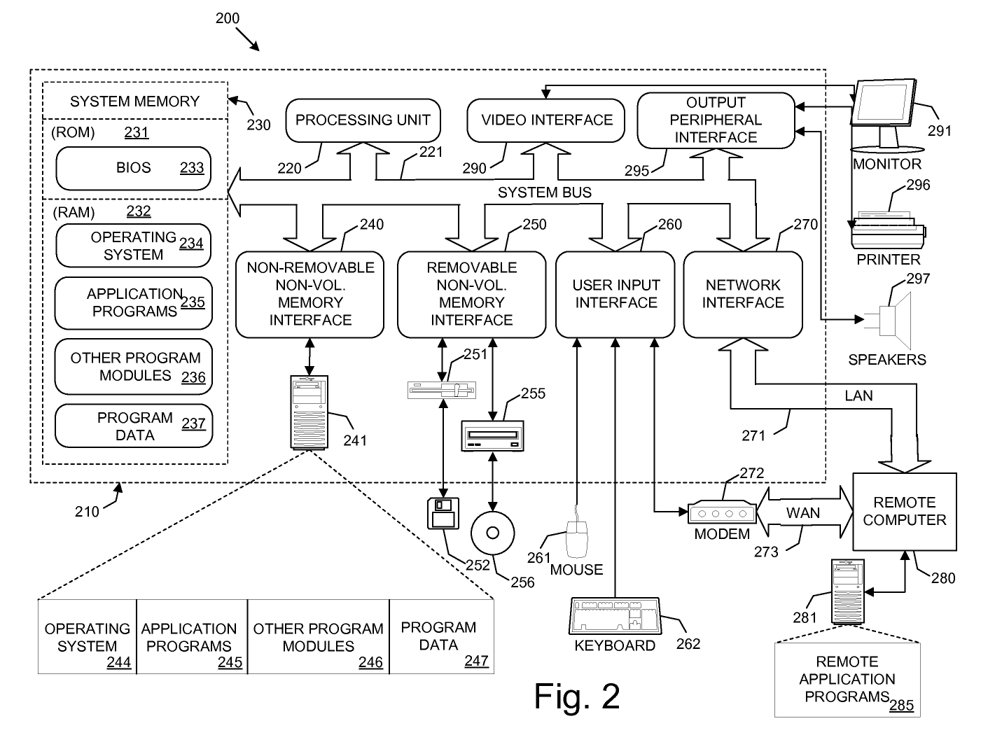

FIG. 2 illustrates an example of a suitable computing device 200 that can be used as or can comprise a portion of a host 10 on which the security system 100 operates, according to an exemplary embodiment of the present invention. Although specific components of a computing device 200 are illustrated in FIG. 2, the depiction of these components in lieu of others does not limit the scope of the invention. Rather, various types of computing devices 200 can be used to implement embodiments of the security system 100. Exemplary embodiments of the security system 100 can be operational with numerous other general purpose or special purpose computing system environments or configurations.

Exemplary embodiments of the security system 100 can be described in a general context of computer-executable instructions, such as one or more applications or program modules, stored on a computer-readable medium and executed by a computer processing unit. Generally, program modules can include routines, programs, objects, components, or data structures that perform particular tasks or implement particular abstract data types. Embodiments of the security system 100 can also be practiced in distributed computing environments, where tasks are performed by remote processing devices that are linked through a communications network.

With reference to FIG. 2, components of the computing device 200 can comprise, without limitation, a processing unit 220 and a system memory 230. A system bus 221 can couple various system components including the system memory 230 to the processing unit 220. The system bus 221 can be any of several types of bus structures including a memory bus or memory controller, a peripheral bus, and a local bus using any of a variety of bus architectures.

The computing device 200 can include a variety of computer readable media. Computer-readable media can be any available media that can be accessed by the computing device 200, including both volatile and nonvolatile, removable and non-removable media. For example, and not limitation, computer-readable media can comprise computer storage media and communication media. Computer storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store data accessible by the computing device 200. For example, and not limitation, communication media can include wired media such as a wired network or direct-wired connection, and wireless media such as acoustic, RF, infrared and other wireless media. Combinations of any of the above can also be included within the scope of computer readable media.

The system memory 230 can comprise computer storage media in the form of volatile or nonvolatile memory such as read only memory (ROM) 231 and random access memory (RAM) 232. A basic input/output system 233 (BIOS), containing the basic routines that help to transfer information between elements within the computing device 200, such as during start-up, can typically be stored in the ROM 231. The RAM 232 typically contains data and/or program modules that are immediately accessible to and/or presently in operation by the processing unit 220. For example, and not limitation, FIG. 2 illustrates operating system 234, application programs 235, other program modules 236, and program data 237.

The computing device 200 can also include other removable or non-removable, volatile or nonvolatile computer storage media. By way of example only, FIG. 2 illustrates a hard disk drive 241 that can read from or write to non-removable, nonvolatile magnetic media, a magnetic disk drive 251 for reading or writing to a nonvolatile magnetic disk 252, and an optical disk drive 255 for reading or writing to a nonvolatile optical disk 256, such as a CD ROM or other optical media. Other computer storage media that can be used in the exemplary operating environment can include magnetic tape cassettes, flash memory cards, digital versatile disks, digital video tape, solid state RAM, solid state ROM, and the like. The hard disk drive 241 can be connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2 can provide storage of computer readable instructions, data structures, program modules and other data for the computing device 200. For example, hard disk drive 241 is illustrated as storing an operating system 244, application programs 245, other program modules 246, and program data 247. These components can either be the same as or different from operating system 234, application programs 235, other program modules 236, and program data 237.

A web browser application program 235, or web client, can be stored on the hard disk drive 241 or other storage media. The web client 235 can request and render web pages, such as those written in Hypertext Markup Language (“HTML”), in another markup language, or in a scripting language. The web client 235 can be capable of executing client-side objects, as well as scripts within the browser environment.

A user of the computing device 200 can enter commands and information into the computing device 200 through input devices such as a keyboard 262 and pointing device 261, commonly referred to as a mouse, trackball, or touch pad. Other input devices (not shown) can include a microphone, joystick, game pad, satellite dish, scanner, electronic white board, or the like. These and other input devices can be connected to the processing unit 220 through a user input interface 260 coupled to the system bus 221, but can be connected by other interface and bus structures, such as a parallel port, game port, or a universal serial bus (USB). The event-tracking unit 110 of the security system 100 can capture user inputs provided through input devices such as these.

A monitor 291 or other type of display device can also be connected to the system bus 221 via an interface, such as a video interface 290. In addition to the monitor, the computing device 200 can also include other peripheral output devices such as speakers 297 and a printer 296. These can be connected through an output peripheral interface 295.

The computing device 200 can operate in a networked environment, being in communication with one or more remote computers 280 over a network. The remote computer 280 can be a personal computer, a server, a router, a network PC, a peer device, or other common network node, and can include many or all of the elements described above relative to the computing device 200, including a memory storage device 281.

When used in a LAN networking environment, the computing device 200 can be connected to the LAN 271 through a network interface or adapter 270. When used in a WAN networking environment, the computing device 200 can include a modem 272 or other means for establishing communications over the WAN 273, such as the internet. The modem 272, which can be internal or external, can be connected to the system bus 221 via the user input interface 260 or other appropriate mechanism. In a networked environment, program modules depicted relative to the computing device 200 can be stored in the remote memory storage device. For example, and not limitation, FIG. 2 illustrates remote application programs 285 as residing on memory storage device 281. As will be discussed in more detail below, the security system 100 can limit traffic over various network connections of the host 10. It will be appreciated that the network connections shown are exemplary, and other means of establishing a communications link between the computers can be used and protected by the security system 100.

Referring now back to FIG. 1, as shown, the security system 100 can utilize virtualization on the host 10. Aspects of the security system 100 can run in a trusted virtual machine (VM) 60, while user application can run in a user virtual machine 65. The security system 100 can leverage a virtualized environment in which the security components reside in one virtual machine 60 and the user performs his everyday work in another virtual machine 65. In some embodiments, a key aspect of the security system 100 is that there may be no need to modify any software in the user virtual machine 65. With the security system's software being in the trusted virtual machine 60, it may be difficult for an attacker to compromise the security provided by the security system 100.

Various types of virtualization exist. In Type I virtualization, where a hypervisor 50 runs directly on the hardware, hardware interrupts go directly to the hypervisor 50, where they are either multiplexed from within the hypervisor 50 or passed to a special virtual machine for multiplexing. In Type II virtualization, where a host operating system runs directly on the hardware, the host operating system receives the hardware interrupts and then multiplexes them to the virtual machines that are running as processes within the host operating system. Either way, the hardware interrupts can be received by the event-tracking unit 110 of the security system 100 before being received by the user VM. As a result, malicious software in the user VM will not be able to forge or modify hardware events before such events without knowledge of the security system 100.

The security system 100 can be application aware. That is, for each application (e.g., email, web browsing) that may be misused by malware to send and hide malicious network traffic or other hardware events, the security system 100 can have prior access to the semantics of that application's user input and how this input maps to data to be sent out of the user virtual machine 65. The security system 100 can also have knowledge about cases in which each application is allowed to automatically generate hardware events (e.g., sending previously composed messages, auto-fetching, or refreshing a web page) that have been implicitly authorized due to previous user actions or application start-up or configuration activities. In other words, the security system 100 can have access to information that links user intent with the observed hardware events from the host 10.

Information about the application can be used by the security system 100 to facilitate a wide variety of security policies, which may be in conjunction with existing security technologies. For example, in a high security setting with a well-known and restricted software installation base (e.g., a bank or government), the security system 100 can be used in conjunction with whitelisting, firewalls, or intrusion prevention systems to prevent unintended network traffic disguised as legitimate application traffic. In this case, the security system 100 could require application knowledge for host applications that use the network in response to user input. For home users or other low security settings, the security system 100, with built-in knowledge of the most commonly used networked applications (such as email, instant messaging, and web browsing), can be used to filter outgoing network traffic in these application protocols to stop the common channels of malicious traffic, such as spam, click fraud, and tunneled traffic, thereby reducing a compromised machine's overall utility to malware.

As shown in FIG. 1, the security system 100 can be driven by hardware events, such as keyboard and mouse events. Although the only hardware devices explicitly shown in FIG. 1 are keyboard and mouse, the security system 100 can react to other hardware events as well or in alternative to these. For example, and not limitation, a hardware event can come from the network, disk, or various other hardware. As shown, a hardware event can be captured by the event-tracking unit 110 and comes to the trusted virtual machine 60. In the trusted virtual machine 60, the security system 100 performs one or more operations before sending notice of the hardware event to the user virtual machine 65. For example, these operations can include identifying whether the hardware event is one with which the security system 100 is concerned, performing application-specific memory analysis using the virtual machine interface (VMI) to create an authorization. The authorization unit 120 can then store the authorization in a database 150, before the hardware event is passed to the user virtual machine 65.

After sending the input hardware event to the user virtual machine 65, the security system 100 can look for outgoing hardware events from the user virtual machine 65. The security system 100 can use transparent redirection to send any outgoing hardware events from the user virtual machine 65 that require an enforcement check to a transparent proxy. This redirection can allow the security system 100 to inspect the outgoing event without any configuration changes, software patches, or other modifications in the user virtual machine 65. When the outgoing event reaches the transparent proxy, the security system 100 can search the database 150 for an authorization matching the event. If such an authorization exists, then the enforcement unit 130 of the security system 100 can allow the outgoing event to proceed. However, if the security system 100 is unable to identify an authorization matching the outgoing event, then the outgoing event can be rejected.

As mentioned above, the authorization unit 120 can dynamically create an authorization for an outgoing hardware event, given an input hardware event. Although the process of creating an authorization can be application-dependent, the security system 100 can follow similar high-level steps regardless of the application receiving the hardware event.

When an input hardware event is recognized by the event-tracking unit 110, the event-tracking unit 110 of the security system 100 can determine whether that input event is relevant to the security system 100. For example, and not limitation, the security system 100 may be concerned with only those input events that generate network traffic. In that case, the security system 100 can ignore non-traffic-generating input events, allowing such events to be processed by the host 10 in a conventional manner.

For some applications, outgoing hardware events may be generated by a particular keystroke (e.g., pressing the ENTER key), a key combination (e.g., pressing the CTRL key and the ENTER key at the same time), or by clicking the mouse in a particular location (e.g., clicking over a button to send an email message). For keyboard events, the event-tracking unit 110 can determine whether the input event is relevant analyzing the particular keystroke of the input event, in light of which application is in focus in the user virtual machine 65. The in-focus application is the program to which the window manager is currently sending keystroke events. The in-focus application can be determined through analysis of the operating system's memory state in the user virtual machine 65. For mouse events, the relevancy check can be performed by analyzing one or more of the mouse event's coordinates, the application window on top at the coordinates, and the user interface widget located under the coordinates. This information related to keyboard and mouse events can be obtained through the VMI.

After the security system 100 identifies information about the input event and thus determines whether it initiates a corresponding outgoing hardware event, the authorization unit 120 can then create an authorization for the outgoing event. In an exemplary embodiment, the authorization is as specific as possible, so as to prevent malware from creating malicious traffic that meets the criteria of the authorization. For example, an authorization that allows an email message to be sent whenever a user clicks on the appropriate user interface component to send an email is not ideal. In that case, malware could use that authorization to send its own email before the user's message is sent. Instead of allowing any email to be sent, the security system 100 can generate an authorization that allows only an email with a specific recipient, subject, and message body. The authorization unit 120 can provide an application-specific authorization for each application supported by the security system 100. The authorization unit 120 can create a precise authorization using various information available, including, for example, introspection, network traffic, storage device contents, and video card frame buffers. The authorization can be stored in an authorization database 150, where it can be retrieved to validate outgoing hardware events from the user virtual machine 65. Depending on the circumstances, the authorization can be one-time, for a limited time period, or can apply indefinitely. The security system 100 can decide a term of an authorization based on the application and the specific circumstances of the input event.

After the authorization is in the authorization database 150, the host 10 can pass the input hardware event to the user virtual machine 65. After this input event arrives at the user virtual machine 65, the application for which the input event was generated can receive the input event and then attempt to send an outgoing hardware event. This outgoing event can be redirected to a transparent proxy in the trusted virtual machine 60. The enforcement unit 130 of the security system 100 can access, or be integrated into, the proxy, so as to verify that the outgoing event is authorized. The enforcement unit 130 can perform content analysis on the outgoing event to determine if the traffic matches an authorization in the authorization database 150.

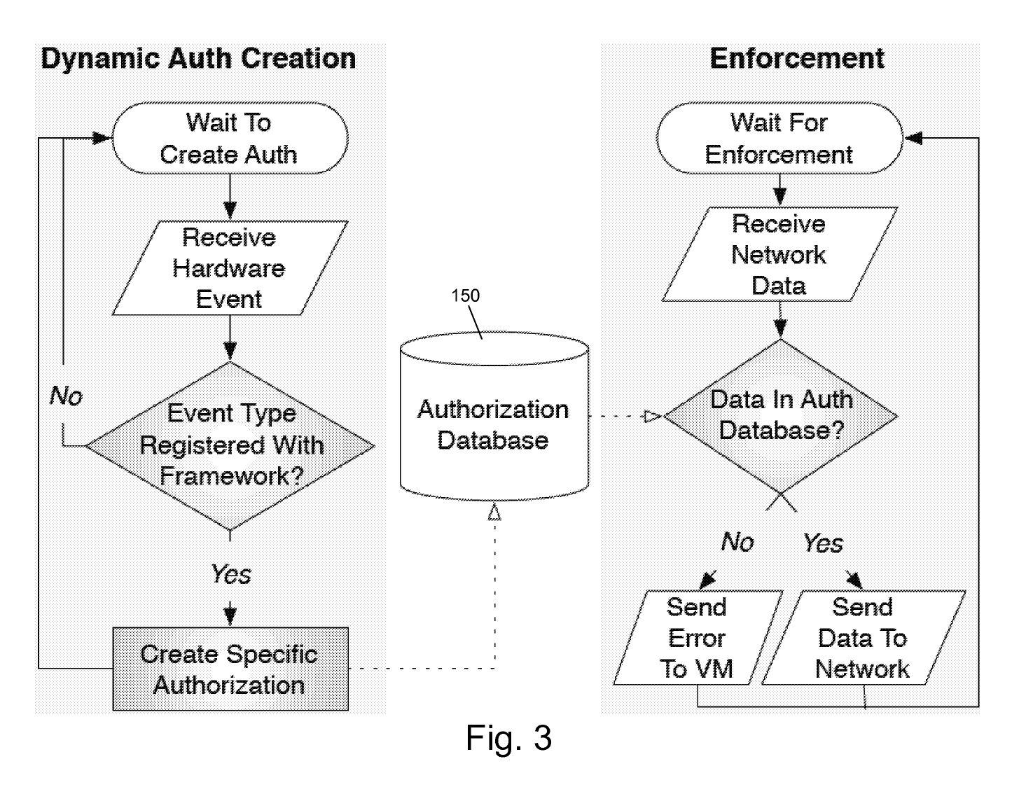

FIG. 3 illustrates a flow diagram of a method authorization and enforcement of network traffic, according to an exemplary embodiment of the present invention. As shown in FIG. 3, the security system 100 can perform two event-driven loops, one for authorization-creation and one for enforcement.

An exemplary embodiment of the security system 100 can be extended to support new applications through modules that specify logic for one or more of the steps shown in FIG. 3. Specifically, the application-dependent steps for which logic may be needed to add a new application are the steps of (1) determining whether the input hardware event is relevant and should therefore be registered with the security system 100, (2) creating a specific authorization for outgoing events based on the input event, and (3) identifying whether a matching authorization exists for attempted outgoing events.

Below, the authorization-creation event-loop will be discussed, followed by discussion of the enforcement loop.

The authorization-creation events can comprise operations of both the event-tracking unit 110 and the authorization unit 120. Before dynamic authorization creation, which may be performed by the authorization unit 120, the security system 100 receives a hardware event. The event-tracking unit 110 can determine whether the input hardware event is relevant and should be processed by the authorization unit 120. Making this determination for keyboard events may require little or no more than checking the specific key, or keys, that was pressed and identifying which application in the user virtual machine 65 will receive the key-press hardware event. Network events may be more complex, but various tools are known in the art for rebuilding network frames and searching for specific information therein. With mouse events, the security system can associate the mouse button pressed and its coordinates with a specific application and UI widget where the mouse click occurred.

Interpreting both keyboard and mouse events requires knowing which application in the user virtual machine 65 will receive these events. To this end, the security system 100 can comprise a window-mapper that utilizes one or more of VMI, memory analysis, and knowledge of the Windows user interface implementation. With the window-mapper, the security system 100 can reconstruct, or reverse-engineer, the widgets and windows that are present on the screen in the user virtual machine 65, including the placement, size, and stacking order of graphical widgets on the screen.

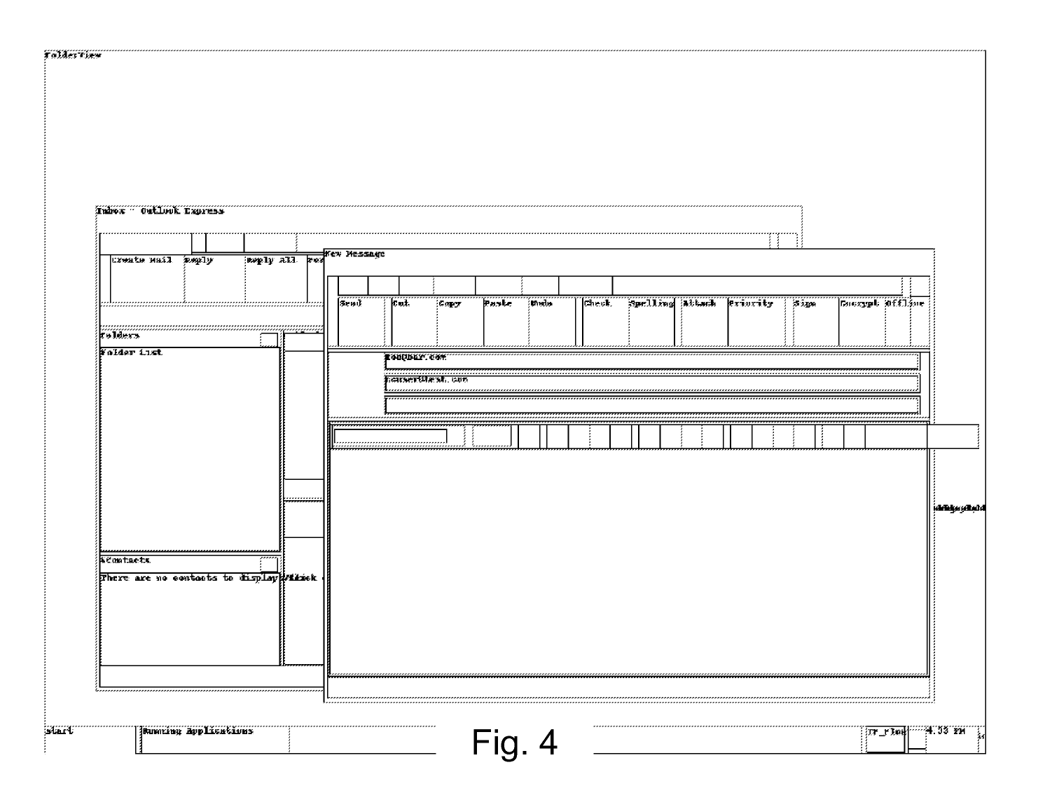

FIG. 4 illustrates an example of a reconstructed interface of the user virtual machine 65, according to an exemplary embodiment of the present invention. Such a reconstruction can provide aspects of the security system 100, running in the trusted virtual machine 60, to determine critical pieces of information about a user's interaction with user virtual machine 65. In Windows, the data structures representing widgets form a tree, where each window has pointers to its next sibling and its first child, as well as a rectangle giving its top-left and bottom-right coordinates. The order of the sibling widgets determines the z-order; if a window or widget is “above” one of its siblings, it will appear earlier in the sibling list. Using this information about Windows, or using analogous information related to whatever operating system is running in the user virtual machine 65, can allow the event-tracking unit 110 of the security system 100 to identify which window and which application will receive a captured mouse event. The event-tracking unit 110 can also determine the specific user interface widget that is associated with a mouse event. For example, using the mouse event coordinates, the event-tracking unit 110 can determine if a particular mouse event will click on the button used to send email or refresh a web page.

For keyboard events, the event-tracking unit 110 can utilize information that Windows stores, in a data structure representing the user's desktop, about the window currently in focus. From this stored information, the event-tracking unit 110 can determine which specific widget inside a window is currently receiving keyboard input, by examining the window's input queue. In this manner, the security system 100 can determine precisely where the window manager will send a given keystroke. For example, and not limitation, the security system 100 can thereby determine whether the user pressed ENTER on the address bar or the search bar of a web browser.

After the event-tracking unit 110 identifies the input hardware event and determines that it is relevant to an outgoing hardware event, the security system 100 can automatically invoke the authorization unit 120. The authorization unit 120 can generate an authorization, based on application-dependent data related to the hardware event, and the authorization unit 120 can store the authorization in the authorization database 150.

In an exemplary embodiment of the security system 100, support of a particular application executable on the user virtual machine 65 can require sufficient knowledge of the application logic to provide the appropriate logic to the event-tracking unit 110, the authorization unit 120, and the enforcement unit 130. In real-world deployment, a security vendor may provide sufficient information to enable the security system 100 to support specific applications, similar to how security vendors provide anti-virus signatures for anti-virus software. Despite this, the inventors of the security system 100 developed a prototype of the security system 100 with support for two applications, an email client and a web browser, to demonstrate the feasibility of supporting various types of applications and network protocols.

### Email Case Study: Outlook Express

To demonstrate email application support, a prototype of the security system 100 was built to support Outlook Express operating on Windows XP. The prototype security system 100 detected when a user interacted with the Outlook Express application to send a message. The security system 100 then extracted the message contents from memory and placed the contents into an authorization database 150 of allowed messages. In other words, the authorization database 150 comprised the specific contents of each message authorized to be sent. When an email was caught attempting to leave the host 10, a transparent SMTP proxy checked that an authorization for a message with matching content was stored in the authorization database 150. As a result, user email was allowed to pass out of the host 10 unhindered, while the security system 100 blocked spam sent by malware on the host 10.

The implementation was divided into several components. First, the event-tracking unit 110 received notification of hardware events and decided whether they represented a user-initiated email. Upon receiving a mouse click event, the window-mapper was consulted to determine whether the user clicked on the “Send” button of an Outlook Express message window. Both “left button down” and “left button up” events on the send button were required, with no intervening mouse button events. If it was determined that the user clicked the send button in this manner, the security system 100 then extracted the message contents.

To create a message-specific authorization, the message contents were retrieved from both memory and the screen capture, although both methods need not be used in every embodiment of the invention. Using memory analysis, the authorization unit 120 traversed the internal data structures used to represent a message while it was being composed.

By reverse engineering portions of Outlook Express, the inventors determined that the message composition pane of Outlook Express was an instance of the MSHTML rendering engine (called Trident), which is also used by Internet Explorer to render web pages. When a user enters text into the window, the MSHTML engine dynamically updates the parsed HTML tree in memory with the new text. When the message is sent, the rendering engine serializes this tree to HTML and sends it using the SMTP protocol. The parsed HTML is stored in memory as a splay tree, which optimizes access to recently used nodes. The nodes of this tree are objects of type CTreePos, and each tree node represents an opening or closing HTML tag or a text string, for the textual content of the page markup. HTML tags are represented by CElement objects, which are accessible from the corresponding CTreePos, and which store the name of the tag and its HTML attributes. Text nodes have no associated CElement and are represented by their length and pointer into a document-wide gap buffer, which is a data structure commonly used to optimize interactive edits to a buffer.

The authorization unit 120 replicated the serialization process by traversing the tree described above and writing out the opening and closing tags, along with the content of any text nodes. The same approach can be used to extract plain text email, by ignoring the HTML tags. The authorization unit 120 also uses memory analysis to retrieve the subject and recipients from the email client's “To” and “Subject” text boxes.

Because some attackers are capable of manipulating message contents in memory, the authorization unit 120 also validated the memory contents by comparing those contents to a screen capture of the message. To this end, the authorization unit 120 identified the bounding boxes of the subject, recipient, and message text from the window-mapper to crop a screen capture down to only the relevant text. Next, after upscaling and resampling the screen capture images to improve readability, the authorization unit 120 extracted the text using optical character recognition (OCR).

If the edit distance between the on-screen and in-memory strings exceeded a predefined, configurable threshold, the message validation failed, and the message would not be placed into the authorization database 150. In practice, it was determined that an error threshold of 20% (relative to the length of the string) was sufficient to compensate for OCR mistakes, while rejecting message contents that had experienced tampering.

At some point after the authorization is provided to the authorization database 150, a corresponding message may be composed matching the authorization. In the prototype security system 100, email messages were sent via SMTP to a mail server. When a message was sent, an iptables rule on the virtual network bridge redirected the network stream to the transparent SMTP proxy, which called the enforcement unit 130. The enforcement unit 130 parsed the message and consulted the authorization database 150 to find one or more messages with a matching subject and recipient. If such a message was identified, the actual content of the message sought to be sent was compared to each authorized message with matching subject and recipient to identify an authorized message with matching subject, recipient, and content. The comparison of message texts was concerned with exact matches, because the copy in the database 150 extracted from memory and was not subject to OCR errors. Any message not found in the database 150 was rejected with an SMTP reject. If a matching message was found in the authorization database 150, the outgoing message was allowed to be sent to the remote mail server. By placing authorizations in the database 150, the security system 100 can allow enforcement to occur at a time later than when the user sends the email, thus enabling for offline sending.

The above general procedure can also be applied to web-based email. Using knowledge of the browser and webmail application semantics, the security system 100 can use memory analysis to determine when the user clicks on the send button in the webmail client's composition page. As with a standalone email client, VMI can be used to extract the message text, validate it using the on-screen display, and place it in the authorization database 150. When the message is sent, an HTTP (rather than SMTP) proxy can be used to filter outgoing webmail messages to ensure they were generated by a human.

### 5.2. Web Browser Case Study: Internet Explorer

The prototype security system 100 also supported Internet Explorer on Windows XP. More specifically, the prototype security system 100 was concerned with the hardware events of (1) hitting ENTER while the address bar had focus and (2) clicking on a link in an open web page. Although monitoring of other hardware vents was not implemented, can exemplary window-mapper of the present invention can provide sufficient information to extend the range of monitored UI events to include other actions, such as clicking the “refresh” or “home” buttons, or selecting a bookmarked URL.

Clicking on the window and pressing ENTER on the address bar were handled by the event-tracking unit 110. Upon receiving notification of the ENTER key being pressed, the event-tracking unit 110 used the window-mapper to determine whether the Internet Explorer address bar had focus. Analogously, when the mouse was clicked, the event-tracking unit 110 used the window-mapper to determine whether the click occurred inside the Internet Explorer content area, and to ensure that no other window was covering the area on which the click occurred. The prototype security system 100 required that both mouse-down and mouse-up events occurred within the Internet Explorer window, with no intervening events.

The case where a user types a URL into the address bar and hits ENTER was handled in much the same way as Outlook Express events. If the event handler determined that the ENTER key was pressed when the address bar was in focus, the authorization unit 120 extracted the URL and added it to the authorization database 150. The URL stored memory was validated using the screen capture. The enforcement module then checked any outgoing HTTP requests to ensure that matching authorizations existed in the authorization database 150.

Handling the case where a user clicks on a link in a web page was handled. Because web browsers show a rendered version of the underlying HTML, the visual representation of a link may have nothing in common with the request generated by clicking on it. VMI was not useful in this case because there was no binding between the visual representation of the link on the screen and its representation in memory. Therefore, an attacker could alter the link target in memory, turning any legitimate user click into a fraudulent request.

To solve this problem, the prototype security system 100 analyzed the incoming network stream Like keyboard and mouse events, this incoming network stream was not under the control of an on-host attacker and could therefore be considered a hardware input event in the context of the security system 100. Incoming HTTP responses were parsed, and their HTML content was analyzed to extract URLs found in the returned web page. These URLs were divided into two categories: (1) automatic URLs, which represented web page dependencies that would be automatically requested by the web browser without any user interaction (e.g., images and stylesheets), and (2) token URLs, which would result in an HTTP request only if the user clicked on them.

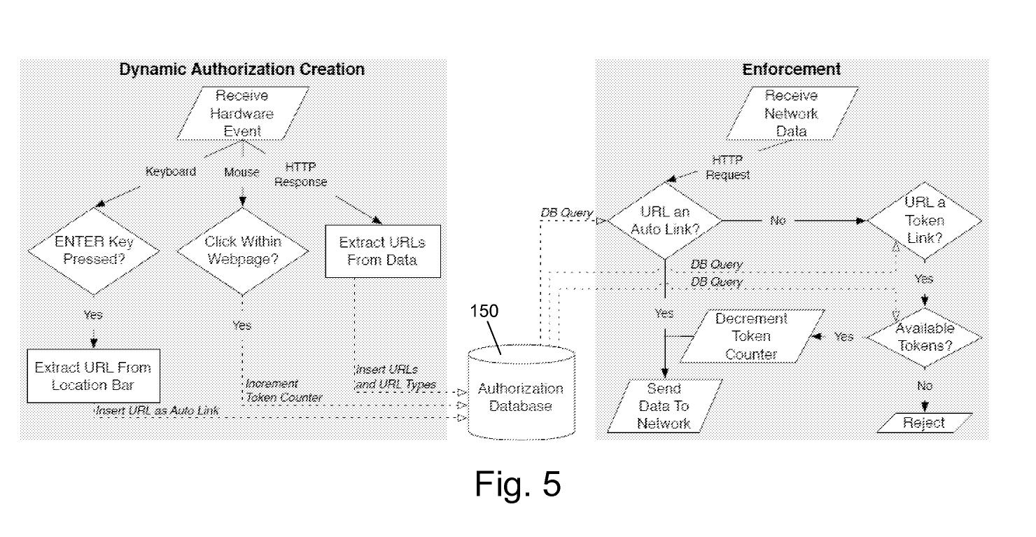

After the page links were categorized, the authorization unit 120 pre-approved all automatic links by adding them to the authorization database 150. This allowed the web page to load normally for the user. All web page dependencies were approved when the initial HTTP response was read, so the enforcement unit 130 would allow the network traffic to pass as the browser made additional requests to complete the page rendering. FIG. 5 illustrates a flow chart depicting how authorization and enforcement are linked by the authorization database 150, according to an exemplary embodiment of the present invention.

Mouse clicks were then handled as follows: The window-mapper determined whether the click was within the Internet Explorer page content widget. If so, a token counter in the authorization database 150 was incremented, and the click was passed on to the operating system of the user virtual machine 65. When the enforcement unit 130 identified an outgoing HTTP request, it determined (1) whether the requested URL was in the token URL database and (2) whether the token counter indicated a positive token count. If both of these criteria were met, the request was allowed to pass, and the token counter was decremented. This ensured that every outgoing HTTP request was matched with a click on the web page. To further improve accuracy, the authorization unit 120 could make use of the information provided by the status bar, to disregard clicks that were not on page links. For example, when the user hovers over a link, the status bar displays information about the link. Accordingly, if the status bar display no link information at the time of a click, then it can be determined that the click does not generate a network request, and no authorization need be generated.

To ensure a strong linkage between the user's interactions and the HTTP requests that prototype security system 100 permitted to leave the host 10, the authorization unit 120 tracked the originating web page for each link in the authorization database 150. When a new link was added to the database 150, the authorization unit 120 noted in the database 150 which web page originated the link. This information was used by the enforcement unit 130, to further limit potential loopholes.

Enforcement of authorizations was performed using a transparent HTTP proxy. Outgoing traffic from the user virtual machine 65 was redirected through the proxy using an iptables rule. The enforcement unit 130 allowed a request to go through only if (1) the URL was in the authorization database 150 as an automatic URL (i.e., it was a dependency of a previously authorized page) or (2) the URL was in the authorization database 150 as a token link and there were tokens remaining according to the token counter. The authorization unit 120 treated request that came from addresses typed into the location bar as an automatic link, so these addresses were allowed by the enforcement unit 130 even if no mouse click occurred.

Thus, the first HTTP request made in the web browser was authorized, because the user must have entered it using the address bar. Subsequent requests the user made, as well as those made by automatic page dependencies, were approved because the authorization unit 120 added the links as token (or automatic) URLs when the previous response was received. Each user request was made either by clicking a link, which incremented the token counter, allowing one request per click to be allowed, or by entering a URL into the address bar.

The enforcement unit 130 used the originating web page for each link to ensure that the HTTP requests permitted at any given time corresponded to links on the web page the user was currently viewing. Using the techniques described above, the enforcement unit 130 obtained the URL from the address bar at the time the HTTP request was processed. The URL was verified with one or more screen capture images, to protect against malicious modification of memory in the user virtual machine 65. Using the URL, the enforcement unit 130 allowed the HTTP request if the originating web page matched the URL. Given that the URL in the address bar indicates the web page a user is currently viewing, this technique successfully restricted the permitted HTTP requests.

Although not implemented in the prototype security system 100, some embodiments of the security system 100 can support JavaScript or other scripting languages. Web scripting languages can be used to modify the content of a web page after it is rendered. In some cases, dynamic code running on the page may even make its own HTTP. To provide more complete scripting support than provided in the prototype security system 100, an exemplary embodiment of the security system 100 can, at the expense of performance, render the web page in another virtual machine and automate clicks on all of the links, in order to extract all of the legitimate URLs. It will be understood, however, that the invention is not limited to this particular implementation of scripting support.

### VoIP Case Study: Skype

Although email and web browsing account for most common personal computing usage, voice over internet protocol (VoIP) services, such as Skype, have grown to nearly four hundred million users worldwide. The prototype security system 100 did not support VoIP services, but such support can be embodied in an exemplary embodiment of the present invention. Skype protocol is officially undocumented, but details of its workings have been previously uncovered through reverse engineering and black box network analysis. The security system 100 can utilize previously identified characteristics of Skype to provide support for Skype.

The security system 100 can divide Skype traffic into several categories: login, user search, call initiation/teardown, media transfer, and presence messages.

An initial hurdle of supporting Skype is the pervasive use of encryption to protect the contents of Skype protocol messages. In order to successfully act on different messages sent by the Skype network, the security system 100 can attempt to decrypt both outgoing and incoming messages. In many cases, this task is not particularly difficult. Skype uses RC4 to encrypt its UDP signaling packets, and the key is derived from information present in the packet, making it possible to de-obfuscate such packets without any additional data. For TCP packets, peers negotiate a longer-lived session key. This key is stored in the memory of the Skype client (SC), running inside the user virtual machine 65, and can therefore be recovered using VMI. Thus, the security system 100 can utilize this information to observe decrypted contents of Skype traffic.

When a Skype client starts, it attempts to make a TCP connection to a Skype super node to join a peer-to-peer network. Connections are attempted to each of the Skype super nodes listed in a host cache, which is stored on the host 10. If the host cache is missing, the Skype client defaults to a list of Skype super nodes embedded in the binary of the Skype client. After a connection to the overlay network is made, the Skype client contacts the Skype login servers, which are centralized and hardcoded into the client, to perform user authentication. To support this phase of the protocol, the security system 100 can whitelist the login and connection establishment messages sent to the login servers and the Skype super nodes in the host cache, by adding these to the authorization database 150 for an indefinite term. The list of hosts to whitelist can be derived using VMI.

Call establishment, teardown, and user search are a good fit for the security system 100 as described in detail above. Call establishment is typically performed when a user clicks the “Call” button while a contact is selected. The security system 100 can monitor mouse clicks and detect when they correspond to a click on the “Call” button. Memory analysis can then be used to extract the username of the contact to whom the call is placed. The contact name can be authenticated by comparing it against a screen capture image. The network messages sent to initiate the call consist of an outgoing connection, either directly to the recipient or to an intermediate relay node. In either case, the security system 100 can inspect the packet metadata to determine the eventual recipient of the call and to verify that the recipient matches the name stored when the user clicked the call button. Call teardown and user search can operate in similar manners, as an extension of the security system 100 as described throughout this disclosure.

After a call is established, the media transfer phase of the protocol begins, in which audio and optional video data is transmitted to the call recipient. Due to the low-latency requirements imposed by real-time conversation, the security system 100 may be implemented to avoid content analysis to verify that the user's voice or video data is faithfully passed on from the microphone or camera and onto the network. Instead, the security system 100 can employ heuristics to estimate an upper bound on the outgoing traffic rate, based on input from the microphone and camera and knowledge of the codecs in use. To add further protection, the security system 100 can periodically sample a portion of the input and resulting network traffic, and can compare them using an audio similarity measure offline. If a discrepancy is detected, the security system 100 can terminate the call.

Skype periodically sends incidental network status updates, such as contact presence notifications and network keep-alives, in order to maintain a connection to the Skype network. As these messages are not particularly useful to an attacker who wishes to send voice or video spam, the security system 100 can whitelist such messages. With these measures in place, the security system 100 can effectively prevent Skype-based spam from being sent.

As discussed above in detail, various exemplary embodiments of the present invention can provide an effective means of distinguishing user-initiated outgoing hardware events from malicious hardware events and can thereby reduce malicious network traffic or stop other malicious activity on the host. While security systems and methods have been disclosed in exemplary forms, many modifications, additions, and deletions may be made without departing from the spirit and scope of the system, method, and their equivalents, as set forth in the following claims.

1. A security system comprising:
an event-tracking unit for capturing a user-initiated input hardware event;
an authorization unit configured to analyze a user interface to determine data related to a first outgoing event initiated by the input hardware event, and to generate a first authorization for the first outgoing event; and
an enforcement unit configured to monitor outgoing events and to block the outgoing events for which matching authorizations are not found

2. The security system of claim 1, the first outgoing event being an instance of outgoing network traffic.

3. The security system of claim 1, the authorization unit being further configured to identify a specific application receiving the input hardware event.

4. The security system of claim 3, the authorization unit being further configured to generate the first authorization based on information about the specific application receiving the input hardware event.

5. The security system of claim 4, the authorization unit being configured to create authorizations for at least one of an email client application, a web client application, and a VoIP application.

6. The security system of claim 3, wherein the specific application is an email client, and wherein the first authorization comprises at least a portion of the contents of an email message visible on the user interface when the input hardware event occurs.

7. The security system of claim 1, the authorization unit including text from the user interface in the first authorization.

8. The security system of claim 1, the authorization unit indicating a term for application of the first authorization.

9. The security system of claim 1, the first authorization being stored in an authorization database.

10. The security system of claim 9, the enforcement unit being further configured to allow the outgoing events for which matching authorizations are found in the authorization database.

11. The security system of claim 10, the enforcement unit being configured to identify the first authorization and to allow the first outgoing event in response to identifying the first authorization.

12. The security system of claim 1, the authorization unit running in a trusted virtual machine.

13. A computer-implemented method comprising:
receiving an input hardware event from a user input device;
determining, with a computer processor, whether the input hardware event initiates an outgoing hardware event;
generating a first authorization specific to the outgoing hardware event initiated by the input hardware event;
storing the first authorization in an authorization repository;
receiving an instance of an outgoing hardware event;
comparing the instance of the outgoing hardware event to the authorization repository; and
blocking the instance of the outgoing hardware event if no authorization corresponding to the instance of the outgoing hardware event is identified in the authorization repository.

14. The computer-implemented method of claim 13, further comprising allowing the instance of the outgoing hardware event if an authorization corresponding to the instance of the outgoing hardware event is identified in the authorization repository

15. The computer-implemented method of claim 13, wherein receiving an instance of an outgoing hardware event comprises receiving an instance of outgoing network traffic.

16. The computer-implemented method of claim 13, further comprising reconstructing one or more windows of a user interface to determine what outgoing hardware events are initiated by the input event.

17. The computer-implemented method of claim 16, further comprising identifying an application that received the input hardware event by analyzing the reconstruction of the one or more windows of the user interface.

18. The computer-implemented method of claim 17, wherein generating the first authorization specific to the outgoing hardware event initiated by the input hardware event is dependent on the application that received the input hardware event.

19. The computer-implemented method of claim 17, wherein generating the first authorization specific to the outgoing hardware event comprises including in the first authorization text visible in the one or more windows of the user interface.

20. The computer-implemented method of claim 13, wherein storing the first authorization in the authorization repository comprises indicating an active term for the first authorization.
